(19) United States
(12) Patent Application Publication
(10) Pub. No.: US 2008/0294837 A1
(43) Pub. Date: Nov. 27, 2008

(54) MEMORY CONTROLLER FOR CONTROLLING A NON-VOLATILE SEMICONDUCTOR MEMORY AND MEMORY SYSTEM

(76) Inventor: Takaya SUDA, Kamakura-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/863,766

(22) Filed: Sep. 28, 2007

(30) Foreign Application Priority Data
Sep. 28, 2006 (JP) 2006-265629

(51) Int. Cl. G06F 12/02

(52) U.S. Cl. 711/103; 711/E12.008

(57) ABSTRACT

A memory controller includes a host interface, a holding circuit and a control circuit. The memory controller controls a semiconductor memory. The semiconductor memory includes memory blocks. The host interface is connectable to a host apparatus and receivable of write data and an address. The holding circuit is capable of holding the address. The control circuit searches information indicating an existence of a parent directory from the write data, and holds the address in the holding circuit when the information is detected. The control circuit successively writes the write data to the same memory block when a new write access is made with respect to the same address as the address held in the holding circuit.

### CROSS-REFERENCE TO RELATED APPLICATIONS

This application is based upon and claims the benefit of priority from prior Japanese Patent Application No. 2006-265629, filed Sep. 28, 2006, the entire contents of which are incorporated herein by reference.

### BACKGROUND OF THE INVENTION

1. Field of the Invention

The present invention relates to a memory controller and memory system. For example, the present invention relates to a memory controller for controlling an operation of a non-volatile semiconductor memory chip.

2. Description of the Related Art

Recently, digital cameras and portable audio players have rapidly come into wide use. Correspondingly, there is a great demand for a large capacity non-volatile semiconductor memory. A NAND type flash memory has been widely used as the non-volatile semiconductor memory.

In the NAND type flash memory, a file allocation table (FAT) is widely used as a file system for managing data. According to the foregoing FAT file system, the NAND type flash memory is provided with a root directory entry holding root directory information. The root directory entry stores information of a file existing in the root directory and information of a sub-directory. Thus, the root directory entry is frequently updated, and has a relatively small data size.

In the NAND type flash memory, data is collectively erased per plural memory cells. The erase unit is hereinafter called as a memory block. In the NAND flash memory, data is not overwritten, due to its characteristics. For this reason, Jpn. Pat. Appln. KOKAI Publication No. 2006-018471 discloses the following method, for example. According to the method, when the root directory entry is updated, another memory block used as a cache is prepared. According to the foregoing method, every time the root directory entry is updated, a root directory entry is added to the memory block given as a cache.

According to this method, it is possible to reduce data movement between memory blocks when the root directory entry is updated, which enables high-speed access. However, there is a problem that it is difficult to update a sub-directory entry having no fixed address.

### BRIEF SUMMARY OF THE INVENTION

A memory controller controlling a semiconductor memory, the semiconductor memory including memory blocks each having nonvolatile memory cells, data in each of the memory blocks being erased simultaneously, the memory controller according to an aspect of the present invention includes:

a host interface which is configured to be connectable to a host apparatus and receivable of write data and an address from the host apparatus;

a holding circuit which is configured to be capable of holding the address; and

a control circuit which searches information indicating an existence of a parent directory from the write data, and holds the address in the holding circuit when the information is detected, the control circuit successively writing the write data to the same memory block when a new write access is made with respect to the same address as the address held in the holding circuit.

A memory system according to an aspect of the present invention includes:

a memory controller described above; and

the semiconductor memory.

### BRIEF DESCRIPTION OF THE SEVERAL VIEWS OF THE DRAWING

FIG. 1 is a block diagram showing a memory system according to a first embodiment of the invention;

FIG. 2 is a table showing a signal allocation to a signal pin in a memory card according to a first embodiment of the invention;

FIG. 3 is a block diagram showing a memory controller included in a memory card according to a first embodiment of the invention;

FIG. 4 is a block diagram showing a flash memory according to a first embodiment of the invention;

FIG. 5 is a circuit diagram showing a memory block included in the flash memory according to a first embodiment of the invention;

FIG. 6 is a conceptual view showing a memory space of the memory system according to a first embodiment of the invention;

FIG. 7 is a conceptual view showing a directory structure of the memory system according to a first embodiment of the invention;

FIG. 8 is a conceptual view showing the configuration of a root directory entry of the memory system according to a first embodiment of the invention;

FIG. 9 is a conceptual view showing a memory space of the memory system according to a first embodiment of the invention;

FIG. 10 is a conceptual view showing the configuration of a sub-directory entry of the memory system according to a first embodiment of the invention;

FIG. 11 is a conceptual view showing the configuration of a sub-directory entry of the memory system according to a first embodiment of the invention;

FIG. 12 is a flowchart to explain a data write method of the flash memory according to a first embodiment of the invention;

FIG. 13 is a conceptual view showing a memory space and a memory block of a memory system according to a first embodiment of the invention, and is a view showing a state that data is updated;

FIG. 14 is a schematic view showing the contents of image data included in the flash memory;

FIG. 15 is a schematic view showing the contents of a boot area included in the flash memory;

FIG. 16 is a circuit diagram showing a sub-directory entry detector included in a memory controller according to a first embodiment of the invention;

FIG. 17 is a flowchart to explain a data write method of a flash memory according to a second embodiment of the invention;

FIG. 18 is a conceptual view showing the configuration of a sub-directory entry of the flash memory according to a second embodiment of the invention;

FIG. 19 is a conceptual view showing the configuration of a sub-directory entry of the flash memory according to a second embodiment of the invention; and

FIG. 20 is a flowchart to explain a data write method of a flash memory according to a third embodiment of the invention.

### DETAILED DESCRIPTION OF THE INVENTION

### First Embodiment

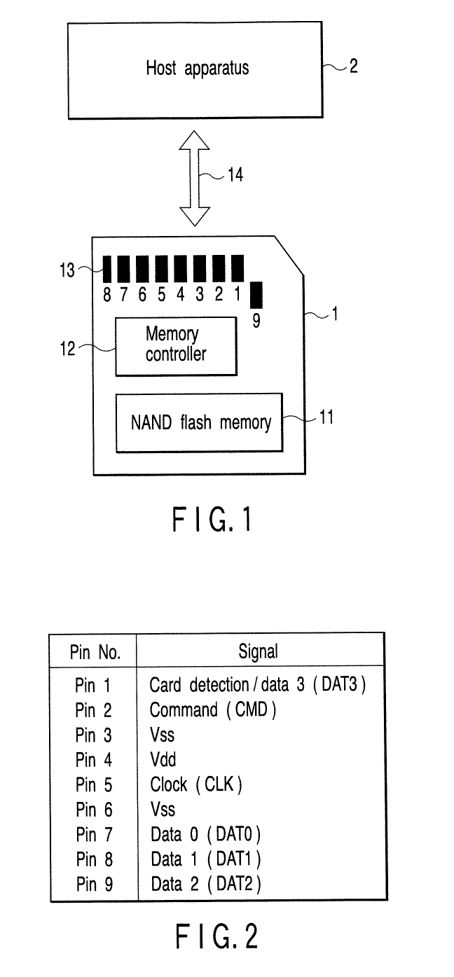

A memory controller according to a first embodiment of the invention will be hereinafter described with reference to FIG. 1. FIG. 1 is a block diagram showing a memory system according to the first embodiment.

As shown in FIG. 1, the memory system includes a memory card 1 and a host apparatus 2. The host apparatus includes hardware and software for making an access to the memory card 1 connected via a bus interface 14. The memory card 1 operates receiving power supply when being connected to the host apparatus 2, and takes procedures in accordance with access from the host apparatus 2. The memory card 1 makes an information exchange with the host apparatus 2 via the bus interface 14.

The memory card 1 will be hereinafter described in detail. As illustrated in FIG. 1, the memory card 1 includes a NAND type flash memory chip (simply referred to as NAND flash memory or flash memory) 11, a memory controller 12 controlling the flash memory chip 11 and a plurality of signal pins (first to ninth pins) 13.

The signal pins 13 are electrically connected with the memory controller 12. The signal allocation to the pins 13, that is, first to ninth pins is set as shown in FIG. 2. FIG. 2 is a table showing the first to ninth pins and signals allocated to them.

Data 0 to data 3 are allocated to seventh, eighth, ninth and first pins, respectively. The first pin is further allocated to a card detection signal. The second pin is allocated to a command, and the third and sixth pins are allocated to a ground potential Vss. The fourth pin is allocated to a power supply potential Vdd, and the fifth pin is allocated to a clock signal.

Moreover, the memory card 1 is formed so that it is inserted to and removed from a slot formed in the host apparatus 2. A host controller (not shown) provided in the host apparatus 2 makes various signal and data communications with the memory controller 12 built in the memory card 1 via the first to ninth pins. For example, when data is written to the memory card 1, the host controller sends a write command to the memory controller 12 as a serial signal via the second pin. In this case, the memory controller 12 captures the write command given to the second pin in response to a clock signal supplied to the fifth pin.

As described above, the write command is serially input to the memory controller 12 using the second pin only. The second pin allocated to a command input is interposed between the first pin for data 3 and the third pin for the ground potential Vss. These signal pins 13 and a bus interface thereto are used for making communications with the host controller in the host apparatus 2 and the memory card 1.

On the contrary, communications between the flash memory 11 and the memory controller 12 is made using a NAND type flash memory interface. Although no illustration is made here, the flash memory 11 and the memory controller 12 are connected via an 8-bit input/output (I/O) line.

For example, when the memory controller 12 writes data to the flash memory 11, the memory controller 12 successively inputs data input command 80H, column address, page address, data and program command 10H to the flash memory via the I/O line. In this case, “H” of the command 80H denotes a hexadecimal number. In fact, an 8-bit signal such as “10000000” is given to a n[“an”?] 8-bit I/O line in parallel. In other words, In the NAND type flash memory interface, a command is given using plural bits.

In the NAND type flash memory interface, command and data communication to the flash memory 11 is done using the same I/O line. As seen from the foregoing description, the interface for making communications with the host controller in the host apparatus 2 and the memory card 1 is different from the interface for making communications with the flash memory 11 and the memory controller 12.

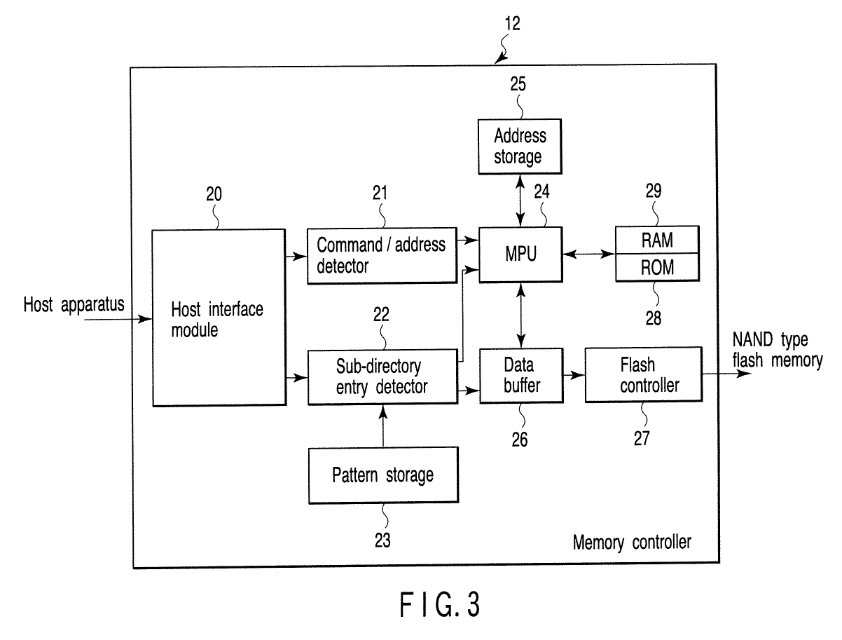

The internal configuration of the memory controller 12 included in the memory card 1 shown in FIG. 1 will be hereinafter described with reference to FIG. 3. FIG. 3 is a block diagram showing the memory controller 12.

The memory controller 12 manages the internal physical state of the flash memory 11 (e.g., which logic sector address data is included in which number physical block address, or which block is in an erased state). The memory controller 12 includes a host interface module 20, a command/address detector 21, a sub-directory entry detector 22, a pattern storage 23, a micro processing unit (MPU) 24, an address storage 25, data buffer 26, a flash controller 27, a read-only memory (ROM) 28 and a random access memory (RAM) 29.

The host interface module 21 interfaces the memory controller 12 with the host apparatus 2. Specifically, the module 21 receives a write command, write address and write data from the host apparatus 2 when data is written. The module 21 outputs the write command and the address to the command/address detector 21, and outputs the write data to the sub-directory entry detector 22.

The command/address detector 21 receives the write command and address from the host interface module 20. The detector 21 outputs the write command to the MPU 24. The command/address detector 21 confirms the address, and thereby, determines whether or not the write command is an update of a root directory entry. The root directory entry will be described later.

The sub-directory entry detector 22 receives the write data from the host interface module 20. The detector 22 detects whether or not the write data is a sub-directory entry using a pattern held in the pattern storage 23. The foregoing pattern and sub-directory entry will be described later. The detector 22 outputs the write data to the data buffer 26.

The MPU 24 controls the whole operation of the memory card 1. For example, when the memory card 1 receives a power supply, the MPU 24 reads out firmware (control program) stored in the ROM 28 on the RAM 29 to execute predetermined processing. In this way, the MPU 24 prepares various tables on the RAM 29. The MPU 24 receives the write command, and read and erase commands from the command/address detector 21. By doing so, the MPU 24 executes predetermined processing with respect to the flash memory 11, and controls data transfer via the buffer 26.

The ROM 28 stores control programs controlled by the MPU 24. The RAM 29 is used as a work area for MPU 24, and stores control programs and various tables.

The flash controller 27 makes interface between the memory controller 12 and the flash memory 11.

The buffer 26 temporarily stores a predetermined amount of data (e.g., equivalent to one page) when the write data sent from the host apparatus 2 is written to the flash memory 11. Moreover, the buffer 26 temporarily stores a predetermined amount of data when data read from the flash memory 11 is sent to the host apparatus 2.

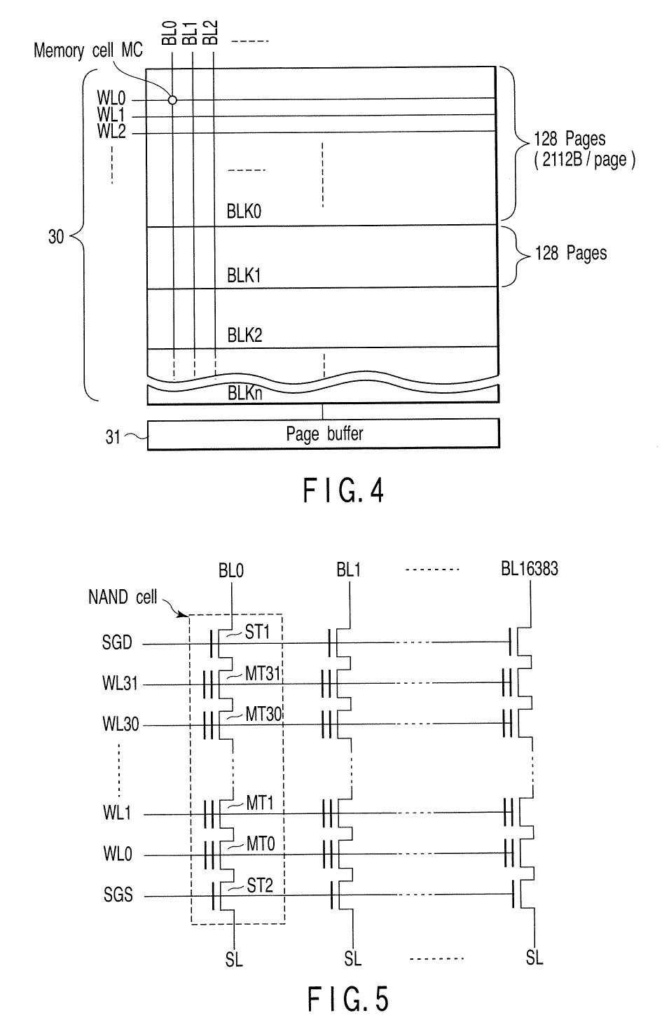

The internal configuration of the NAND type flash memory 11 will be briefly described. FIG. 4 is a block diagram showing the NAND type flash memory 11. As shown in FIG. 4, the NAND type flash memory 11 includes a memory cell array 30 and a page buffer 31.

The memory cell array 30 includes a plurality of memory cell blocks BLK0 to BLKn (n is a natural number more than 2. In the following description, the memory cell blocks BLK0 to BLKn are simply called a memory block BLK. Data erase is made in units of memory blocks BLK. In other words, data existing in the same memory cell block BLK is collectively erased. Each of the memory cell blocks BLK includes a plurality of memory cells MC. Each of the memory cells is a MOS transistor including a stacked gate having a charge storage layer (e.g., floating gate) and a control gate. The memory cell block BLK is provided with a plurality of word lines WL0, WL1, . . . (referred to as word line WL) and bit lines BL0, BL1, . . . (referred to as bit line BL) perpendicular to the word line WL. The memory cells existing in the same row are connected to the same word line in common. Memory cells existing in the same column are connected to the bit line BL in common in units of plural memory cells. Data write and read are carried out for every set of plural memory cells. The set of the memory cells is called one page. In the read and write operation, any word line is selected according to a row address, while any bit line is selected according to a column address. As seen from the example of FIG. 4, each page of the flash memory 11 has 2112 bytes (512 byte data storage×4+10 byte redundancy×4+24 byte management data storage). Each memory block BLK includes 128 pages.

The page buffer 31 inputs/outputs data to the flash memory 11, and then, temporarily holds the data. The data size that can be held by the page buffer is the same 2112 bytes (2048 bytes+64 bytes) as the page size of each memory block BLK. In the data write operation, the page buffer 31 executes data input/output to the flash memory 11 at a unit of one page equivalent to the self storage capacity. In the following description, redundancy and management data storage are omitted for simplification, and the data size of one page is set as 2048 bytes.

FIG. 5 is a circuit diagram showing a memory block BLK. As depicted in FIG. 5, the memory block BLK includes 16384 NAND cells, for example. Each of the NAND cells includes 32 memory cell transistors MT0 to MT31, and select transistors ST1 and ST2. If the memory cell transistors MT0 to MT31 are not distinguished, it is simply called a memory cell transistor. A current path of the memory cell transistors MT0 to MT31 is connected in series between a drain of the select transistor ST2 and a source of the select transistor ST1. The memory cell transistor MT is equivalent to the foregoing memory cell MC.

The source of the select transistor ST2 is connected to a source line SL in common. The drain of the select transistor ST1 is connected to any of 16384 bit lines BL0 to BL16383. These bit line BL0 to BL16383 connect a NAND cell in common between plural memory blocks BLK. In the following, if the bit lines BL0 to BL16383 are not distinguished, these are simply called as a bit line BL. Control gates of memory cell transistors MT0 to MT31 in the same memory block BLK are connected to word lines WL0 to WL31. Gates of the select transistors ST1 and ST2 are connected to select gate lines SGD and SGS.

According to the foregoing configuration, data is collectively written to 16384 memory cell transistors connected to any word line WL.

Each of the memory cell transistors MT holds 16 values (16-levels, 4 bit data) data, in accordance with a threshold voltage. The 4 bit data is written in units of each bit. Consequently, one memory block BLK includes (32 WLs×4 bit)=128 pages, and memory capacity of one memory block is (16384 BLs×32 WLs×4 bit)=256 KB. Of course, each of the memory cell transistors MT may hold two values (2-levels, 1 bit data), four values (4-levels, 2 bit data), or eight values (8-levels, 3 bit data).

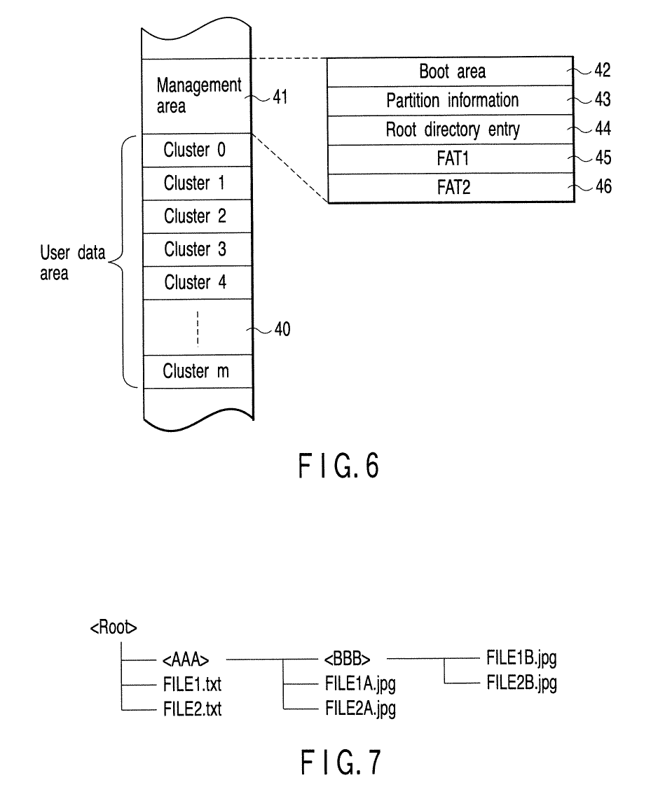

FIG. 6 is a conceptual view showing a memory space of the memory system. As seen from FIG. 6, the memory space is largely divided into a user data area 40 and a management area 41.

The user data area 40 is an area storing net data written by a user.

The management area 41 is used for managing a file (data) recorded in the memory system, and holds file management information. As described above, a system managing a file (data) recorded in the memory is called a file system. In the file system, the following systems are determined. One is a system for creating information of a file and a folder in the memory. Another is a system for moving and deleting the file and the folder. Another is a data recording system. Another is a system for using a part of a management area or method for using a management area. A file allocation table (FAT) file system is shown as one example in FIG. 6.

For example, the management area 41 includes a boot area 42, a partition information area 43, a root directory entry 44, FAT1 (45) and FAT2 (46). The boot area 42 stores boot information. The partition information area 43 stores partition information. The FAT1 and the FAT2 store which cluster data is stored. The root directory entry 44 stores root directory information. The root directory entry 44 stores which cluster shown in FAT1 and FAT2 is a the header cluster of the file together with file name or folder name, file size, attribute and file updated date and time.

The user data area 40 includes a plurality of areas, called clusters. If the written data is larger than the cluster size, the data is stored in a state of being divided into cluster units. In this case, the cluster to which data is written is not continuous. In other words, one piece of data is written to separate clusters. In such a case, management data for managing that data is divided and written to which cluster is stored in FAT1 and the FAT2.

To given an example, the directory structure of the memory system is as shown in FIG. 7. FIG. 7 is a conceptual view showing a directory tree. In FIG. 7, symbols “<” and “>” denote a directory. As shown in FIG. 7, the root directory includes a sub-directory “AAA”, two text files “FILE1.txt” and “FILE2.txt”. The sub-directory “AAA” includes a subdirectory “BBB”, two image files “FILE1A.jpg” and “FILE1B.jpg”. Further, the sub-directory “BBB” includes two image files “FILE1B.jpg” and “FILE2B.jpg”.

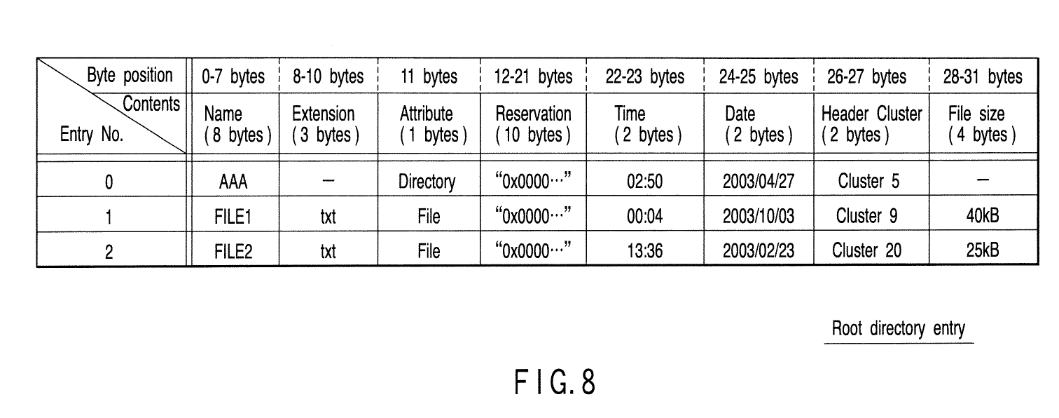

The content of the root directory entry 44 having the foregoing directory structure will be hereinafter described with reference to FIG. 8. FIG. 8 is a conceptual view showing the configuration of the root directory entry 44. The root directory entry 44 includes a plurality of entries each having 32 bytes. Each entry holds information related to a file included in the root directory or to the sub-directory.

Each entry holds the following information in the order of the header byte position of 32 bytes. According to the order of the header byte position, a file or sub-directory name (8 bytes), an extension (3 bytes), an attribute (1 byte), reservation (10 bytes), recording time (1 byte), recording date (1 byte), a header cluster (2 bytes) and a file size (4 bytes) are given. The attribute is information as to whether or not the item is a directory or file or read-only file or hidden file or system file. In 10-byte data showing reservation, the first 2-bytes are “0x0000”. “0x” added to the header of the data means that the data is a hexadecimal number. The header cluster means the header cluster stored with a sub-directory entry of the sub-directory and file. Usually, the cluster size is 16 kB. For example, if the file “FILE.txt” is 40 kB, the file size is larger than the cluster size. Thus, the file is divided into a cluster unit size, and then, stored in a free cluster. In other words, the file is written using three clusters. The cluster is not always continuous; therefore, the file is stored using clusters 5, 6 and 8, for example. In this case, the header cluster 5 is held in the root directory entry 44. FAT1 and FAT2 manage which cluster the file is divided and stored in. FAT1 and FAT2 are stored with the same data. If one FAT has a defect, the data is restored using the other FAT. FAT1 and FAT2 store cluster information allocated to the file, and store cluster link relationships. The file is restored to the original file by tracing information stored in the FAT1 and FAT2.

Specifically, of 40 kB of the divided file “FILE1.txt”, the first-half 16 k bytes are stored in the cluster 5, and the next 16 kB is stored in the cluster 6. The second-half 8 k bytes are stored in the cluster 8. Therefore, FAT1 and FAT2 are stored with the following information. Namely, clusters 6 and 8 are linked next to the cluster 5. In order to read the file divided into three clusters, the file is restored by chain-connecting this information stored in FAT1 and FAT2.

When data is written in the flash memory using the foregoing file system, information of the root directory entry 44 and FAT management information must be updated.

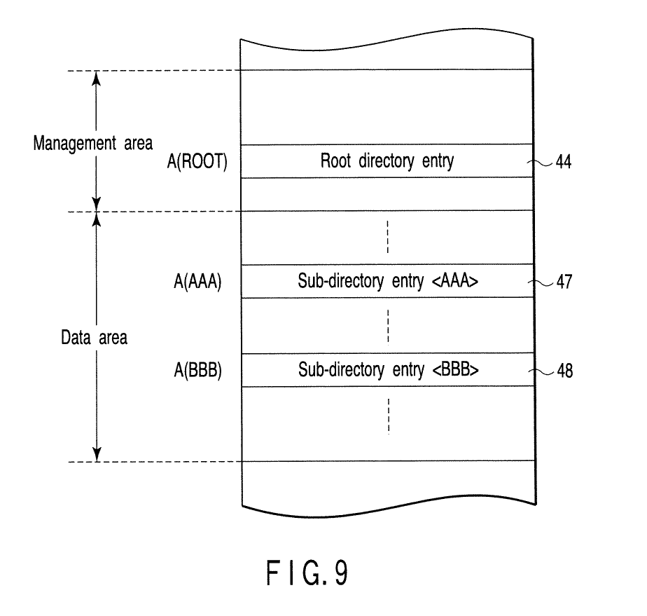

The following is a description of a sub-directory entry. A sub-directory “AAA” is created in the root directory, and then, a sub-directory “BBB” is further created in the sub-directory “AAA”. In this way, a sub-directory entry showing information in the sub-directory is created. FIG. 9 is a conceptual view showing an address space of the memory system, considering the root directory entry and sub-directory entry.

As shown in FIG. 9, the root directory entry 44 is recorded to a predetermined area in the management area 41. An address A (ROOT) of the area holding the root directory entry 44 is determined from the beginning, and the value is already known. On the contrary, the sub-directory entry is recorded to any free area in the user data area 40. In other words, addresses A (AAA) and A (BBB) of the sub-directory entries 47 and 48 related to sub-directories “AAA” and “BBB” are not previously determined. The sub-directory entries 47 and 48 are determined when being created.

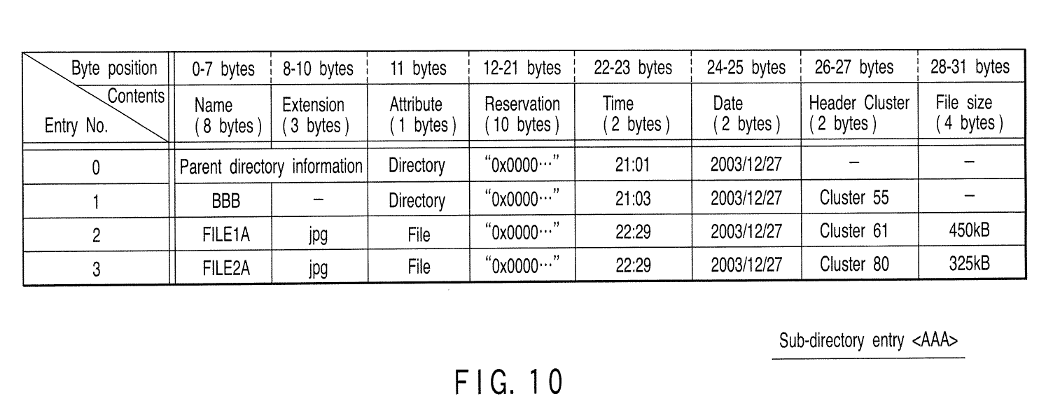

The configuration of the sub-directory entry 47 related to the sub-directory “AAA” will be described as one example with reference to FIG. 10. FIG. 10 is a conceptual view showing the configuration of the sub-directory entry 47. As depicted in FIG. 10, the sub-directory entry 47 holds directory and file information existing in the sub-directory “AAA”, like the root directory entry 44. A plurality of entries each includes 32 bytes. Each entry holds the following information in the order of the header byte position of 32 bytes. According to the order of the header byte position, a file or sub-directory name (8 bytes), an extension (3 bytes), an attribute (1 byte), reservation (10 bytes), recording time (1 byte), recording date (1 byte), a header cluster (2 bytes) and a file size (4 bytes) are given.

However, the sub-directory is different from the root directory entry 44 in the following point. Specifically, parent directory (directory existing at higher level than the current directory) information is recorded using one entry before the directory and file information included in the sub-directory. According to the example shown in FIG. 10, the parent directory information is held using the first 11 bytes of the entry 0. In the parent directory information, attribute, reservation, recording time and recording date are held. In entries 1 to 3 following the entry 0, directory “BBB”, file “FILE1A.jpg, and file “FILE1B.jpg” are held. The content of the sub-directory entry is the same as the root directory entry 44.

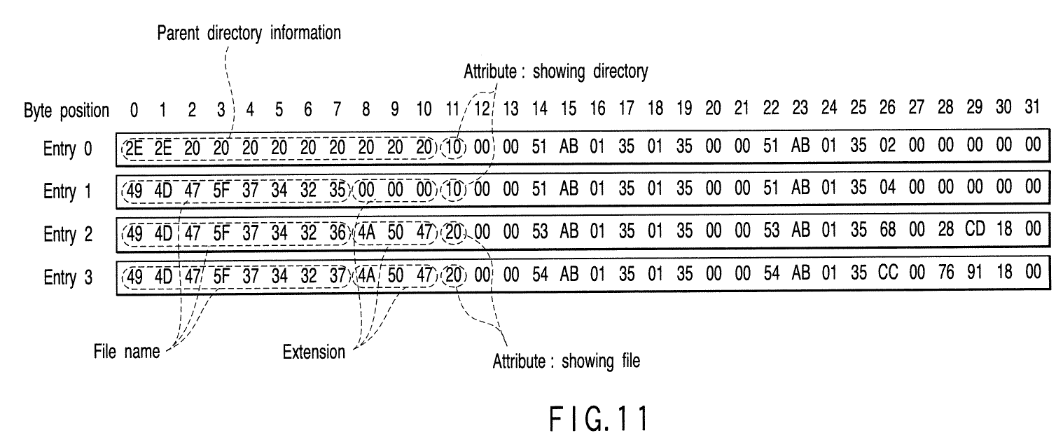

The configuration of the sub-directory entry 47 will be hereinafter described in detail with reference to FIG. 11. FIG. 11 is a schematic view showing the sub-directory entry 47, and shows each entry and data in a byte position. Each value of data is shown using hexadecimal and two digits. Values shown in FIG. 11 do not always coincide with the name and time shown in FIG. 10.

As shown in FIG. 11, a 0-10 byte position of the entry 0 holds a value such as “0x2E2E202020202020202020”. This is parent directory information, and the value is the same in any sub-directory. The pattern held by the pattern storage is the value such as “0x2E2E202020202020202020”. On the contrary, a 0-10 byte position of entries 1 to 3 holds a file name and extension. Incidentally, the directory has no extension; therefore, an 8-10 byte position of the entry 1 holds a value such as “0x000000”. An 11 byte position of entries 0 to 3 holds a value showing the attribute. In FIG. 11, a value showing the attribute of a directory or file is held. If the attribute indicates a directory, “0x10” is held. If the attribute indicates a file, “0x20” is held.

The sub-directory entry differs from the root directory entry in the following point. Namely, parent directory information is held at the 0-10 byte position in any entry in place of a file (directory) name and extension. The parent directory information means that a directory exists at the higher level than the sub-directory. Thus, parent directory information of the directory <AAA> under the root directory and parent directory information of the directory <BBB> under the sub-directory are both “0x2E2E202020202020202020”. Of course, depending on the file system, the data value showing the ancestor directory information may not be “0x2E2E202020202020202020”. In other words, the value is not especially limited, and the following information may be given such that a higher directory than the current directory exists.

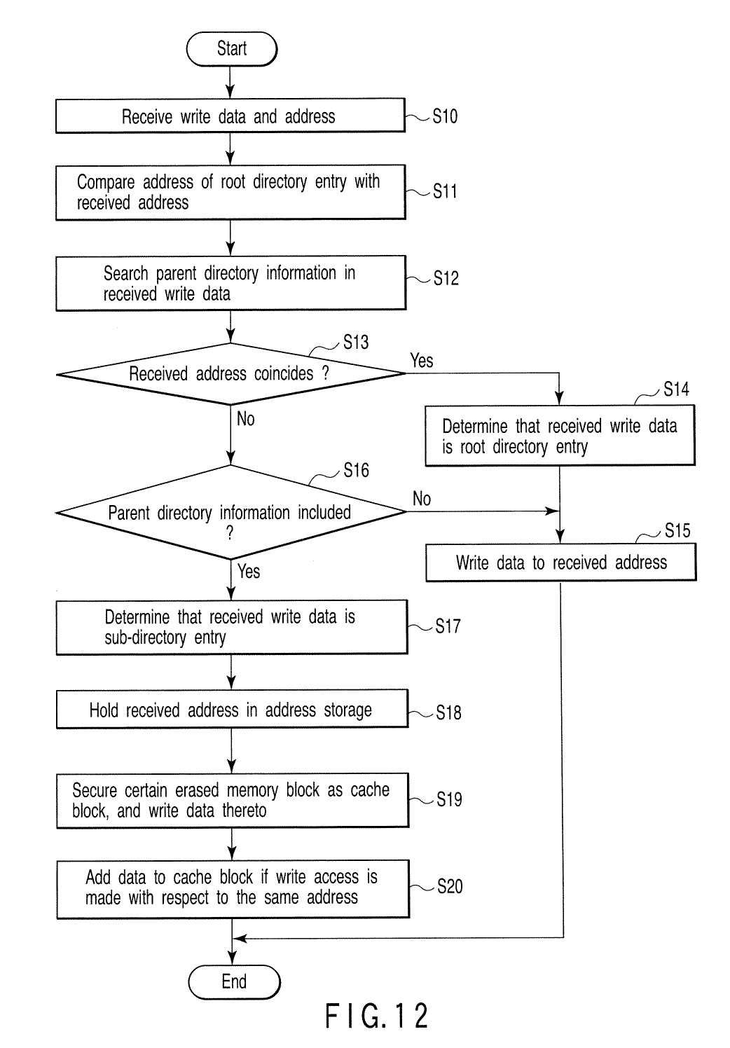

The data write operation of the memory controller 12 having the foregoing configuration will be described considering update of the root directory entry and the sub-directory entry in particular. FIG. 12 is a flowchart to explain the data write operation.

As shown in FIG. 12, the host interface module 20 receives a write command from the host apparatus 2 together with write data and address (step S10). The host interface module 20 outputs the write command and the address to the command/address detector 21 while outputs the write data to the sub-directory entry detector 22.

The command/address detector 21 compares the address A (ROOT) of the root directory entry 44 with the received address (step S11). As described before, the address A (ROOT) is an already known value, and the command/address detector 21 holds this value. The command/address detector 21 outputs the comparison result and the write command to the MPU 24. The sub-directory entry detector 22 reads a pattern (“0x2E2E202020202020202020”) showing parent directory information from the pattern storage 23. The sub-directory entry detector 22 searches the pattern showing the parent directory information in the write data received from the host interface module 20 (step S12). Thereafter, the sub-directory entry detector 22 outputs the search result to the MPU 24, and outputs the write data to the data buffer 26.

If the received address coincides with the address A (ROOT) in step S11 (YES in step S13), the MPU 24 determines that the write data is a root directory entry, and an update instruction of the root directory entry is given (step S14). Then, the MPU 24 gives instructions to write data given from the host apparatus 2 in a memory area corresponding to the received address to the data buffer 26 and the flash controller 27 (step S15).

If the received address does not coincide with the address A (ROOT) in step S11 (NO in step S13) and it is determined that the parent directory information is not included (NO in step S16), the MPU 24 determines that the write data is a normal data file and not root directory and sub-directory. The flow proceeds to step S15.

Conversely, search by the sub-directory entry detector 22 is made; as a result, the parent directory information is found (YES in step S16). In this case, the MPU 24 determines that the write data is a sub-directory entry (step S17). The MPU 24 holds the address received from the command/address detector 21 in the address storage 25 (step S18). The MPU 24 secures any erased memory block in the memory cell array 30 as a cache block to write the data to the secured cache block (step S19). Thereafter, if a write access is made with respect to the same address, the MPU 24 adds the data to the cache block secured in step S19 (step S20).

Whether or not the write access is made with respect to the same address is determined in the following manner. Namely, the command/address detector 21 or the MPU 24 compares the address received from the host apparatus 2 with the address held in the address storage 25, and thus, determines whether or not two addresses coincide.

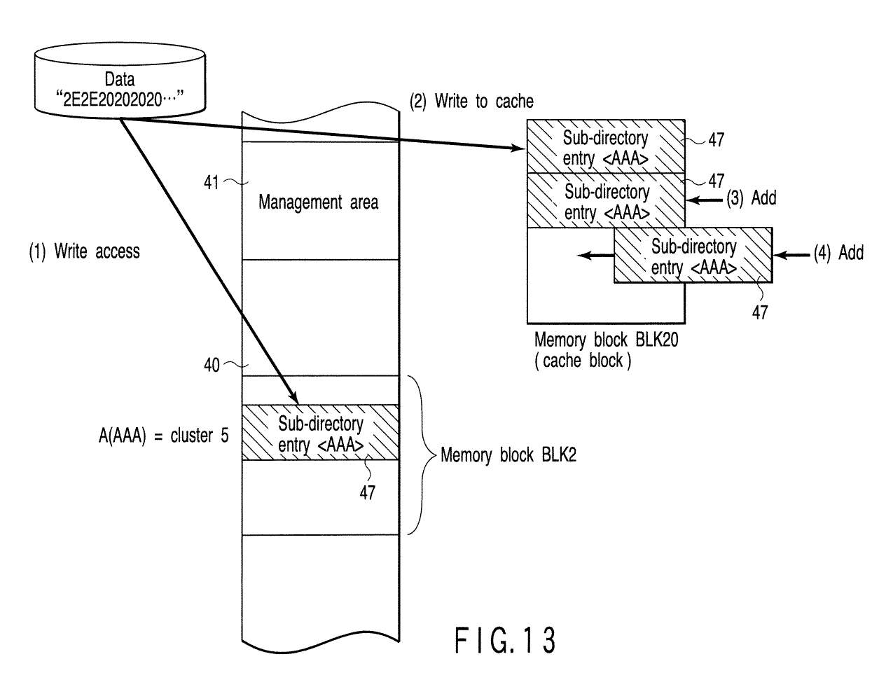

The foregoing operation will be hereinafter described with reference to FIG. 13. FIG. 13 is a schematic view showing a state that the sub-directory entry 47 related to the sub-directory “AAA” is updated, and shows a memory space and a memory block. As described in FIG. 8, the header cluster of the sub-directory entry 47 is the cluster 5. The address of the cluster 5 is A (AAA), and corresponds to a memory block BLK 2.

A write access is made with respect to the address A (AAA) from the host apparatus 2 (step S10, (1) of FIG. 13). The write access is an update instruction of the sub-directory entry 47. However, the memory controller 12 does not recognize it when the access is made. For this reason, the memory controller 12 confirms the address related to the write access, and then, searches within the data (steps S11, S12). The parent directory information is found at the 0-10 byte position of the entry 0 in FIG. 11 (YES in step S16). The MPU 24 secures an erased memory block BLK20 as a cache block independently from the memory block BLK2, and thereafter, writes the data to the memory block BLK20 (step S19, (2) of FIG. 13). Then, the MPU 24 grasps the fact that the data held in the address A (AAA) is a sub-directory entry. Thereafter, if a write access is made with respect to the address A (AAA), the MPU 24 adds the data to memory block BLK20 (step S20, (3) and (4) of FIG. 13).

As described above, according to the memory system of this embodiment, high-speed access is possible when the sub-directory entry is updated. The effect will be hereinafter described.

In the NAND type flash memory, the write address corresponding to the directory entry has no change when the same file or folder is updated. Thus, there is a need to overwrite the same address data. However, in the NAND type flash memory, overwrite is not made with respect to the already written page. In an overwrite operation, erase must be previously carried out. The erase is carried out in units of memory blocks only. Therefore, when data is updated, update data is newly written to an erase memory block. Simultaneously, other data stored in the memory block holding data before update must be copied to the erase memory block (this is called a copying process). For this reason, even if data smaller than the memory block size is updated, data must be written to the erase memory block in units of memory blocks. In other words, even if the data size is small, a large amount of data movement is given in the case where the copying process is necessary. As a result, the write speed is reduced, and it is difficult to make a high-speed access to the memory card 1.

In order to solve the foregoing problem, when a small amount of data is written, a memory block different from the memory block to be inherently written is used as a cache block. This method is employed, and thereby, when certain data is updated, the data is added to the memory block used as a cache block. Namely, every when certain data is updated, the data is successively written to the memory block secured as a cache block in units of pages. For example, the newest update data only is moved at a timing such as when the memory block using as a cache block is full. By doing so, it is possible to reduce the number of the copying processes.

In particular, a root directory entry and sub-directory entry are given as an example that updating is frequent and the data size is small. When the foregoing root directory entry and sub-directory entry are updated, a cache is preferably provided. In this case, the address of an area holding the root directory entry is fixed. Therefore, as described in the Related Art, when a write access is made, it is possible to determine from the address whether or not the data is a root directory entry. However, as described above, the address of the sub-directory entry is not fixed, but the sub-directory entry is created in a free cluster every when a sub-directory is created. Thus, it is impossible to determine from the address whether or not the data is a sub-directory entry.

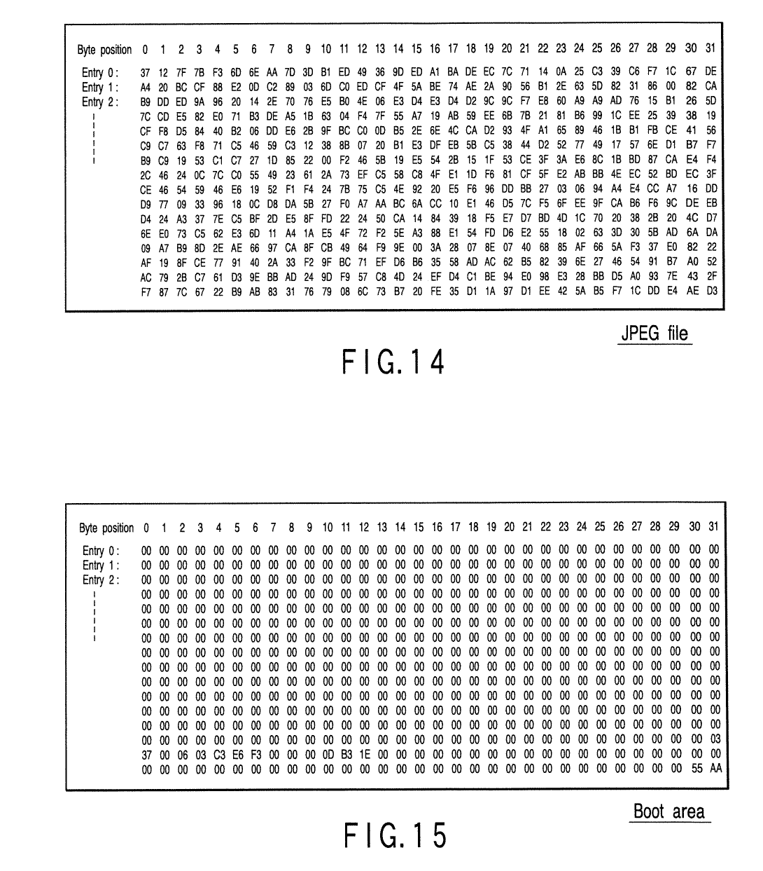

According this embodiment, considering the configuration of the sub-directory entry, a search is made as to whether or not parent directory information is included in the data to determine whether or not the data is a sub-directory entry. Specifically, the write data shown in FIG. 11 is searched to investigate whether or not a value such as parent directory information, that is, “0x2E2E202020202020202020” exists. FIG. 14 shows the data configuration of a joint photographic expert group (JPEG) format image file, and FIG. 15 shows the data configuration of a boot area. As depicted in FIG. 14 and FIG. 15, in the image file and the boot area, the value such as parent directory information “0x2E2E202020202020202020” is not included. Of course, depending on data, there is a possibility that the same value as the parent directory information is included. However, the probability is very low. Data including the value “0x2E2E202020202020202020” is substantially a sub-directory entry.

As seen from the foregoing description, the method according to this embodiment can effectively detect both a root directory entry and sub-directory entry. When a root directory entry and sub-directory entry are detected, a cache is prepared for the data, and thereby, the data write speed is improved, and in addition, high-speed access to the memory card 1 is possible.

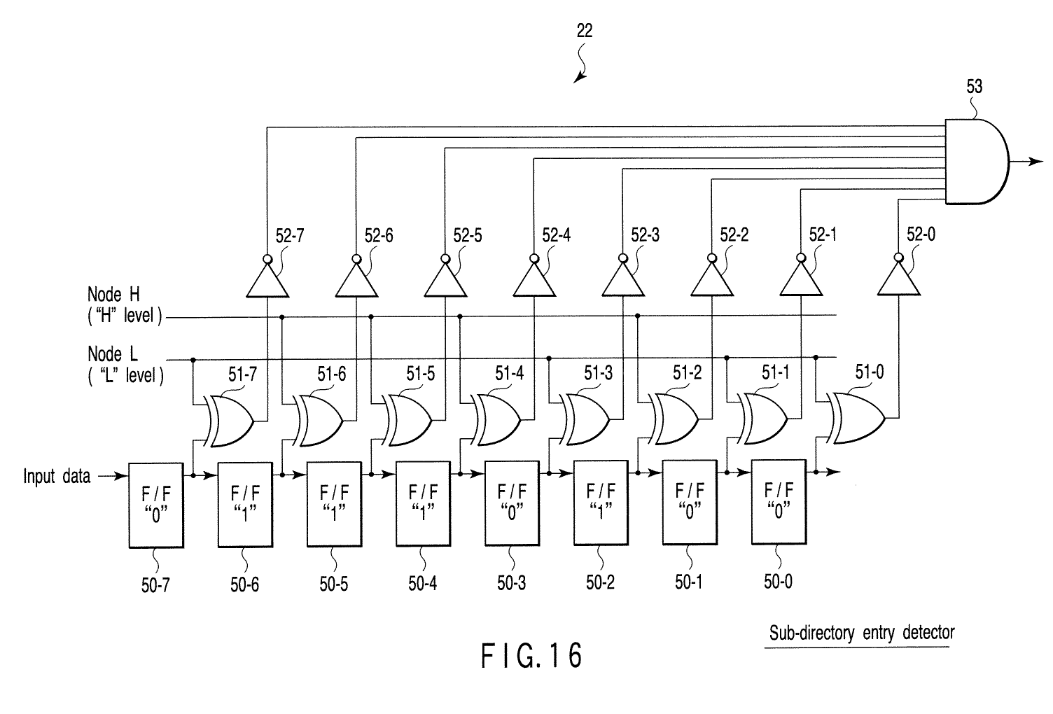

FIG. 16 is a circuit diagram showing the configuration of the sub-directory entry detector 22. As shown in FIG. 16, the sub-directory entry detector 22 includes 8 flip-flops 50-0 to 50-7, exclusive OR gates (hereinafter, referred to as EXOR gate) 51-0 to 51-7, inverters 52-0 to 52-7 and an AND gate 53. The flip-flop 50-7 is input data by one bit in binary from the host interface module 20. Data of flip-flop 50-(i+1) is transferred to flip-flop 50-i (i is a natural number from 0 to 6). FIG. 16 shows a state that data “0x2E”=“00101110” is input.

The EXOR gates 51-0 to 51-7 each makes an exclusive OR operation of each output of flip-flops 50-0 to 50-7 and a value (“H” or “L” level) to be detected. When the foregoing two inputs coincide with each other, the EXOR gate output the “L” level. Conversely, if the two inputs are different, the EXOR gate outputs the “H” level. FIG. 16 shows the case of detecting “0x2E”. Therefore, EXOR gates 51-0, 51-1, 51-3 and 51-7 are supplied with an “L” level from the node L. Other EXOR gates 51-2, 51-4 to 51-6 are supplied with an “H” level from the node H. Inverters 51-0 to 52-7 invert respectively the output of the EXOR gates 51-0 to 51-7. The AND gate 53 makes AND operation of the outputs of the inverters 52-0 to 52-7.

According to the foregoing configuration, it is possible to determine whether or not hexadecimal two-digit (=binary 8-digit) data input to the flip-flops 50-0 to 50-7 is equal to a predetermined value. If the data is equal to the predetermined value, the output of the AND gate 53 is of the “H” level. When the value “0x2E2E202020202020202020” is detected, it is determined whether or not the value has “0x2E” in FIG. 16. Of the write data, the next binary 8-digit value is transferred to the flip-flops 50-0 to 50-7 to determine whether or not the value has “0x2E”. Of the write data, the binary 8-digit value is transferred to the flip-flops 50-0 to 50-7. Simultaneously, EXNOR gates 51-0 to 51-7 are each supplied with “L”, “L”, “H”, “L”, “L”, “L”, “L” and “L” from nodes L and H. In this way, it is determined whether or not the input data has “0x20”. The foregoing operation is repeated nine times. Via the above 11-times determination, if the output of the AND gate 53 becomes all “H” level, it can be seen that the value “0x2E2E202020202020202020” is given from the host apparatus 2.

### Second Embodiment

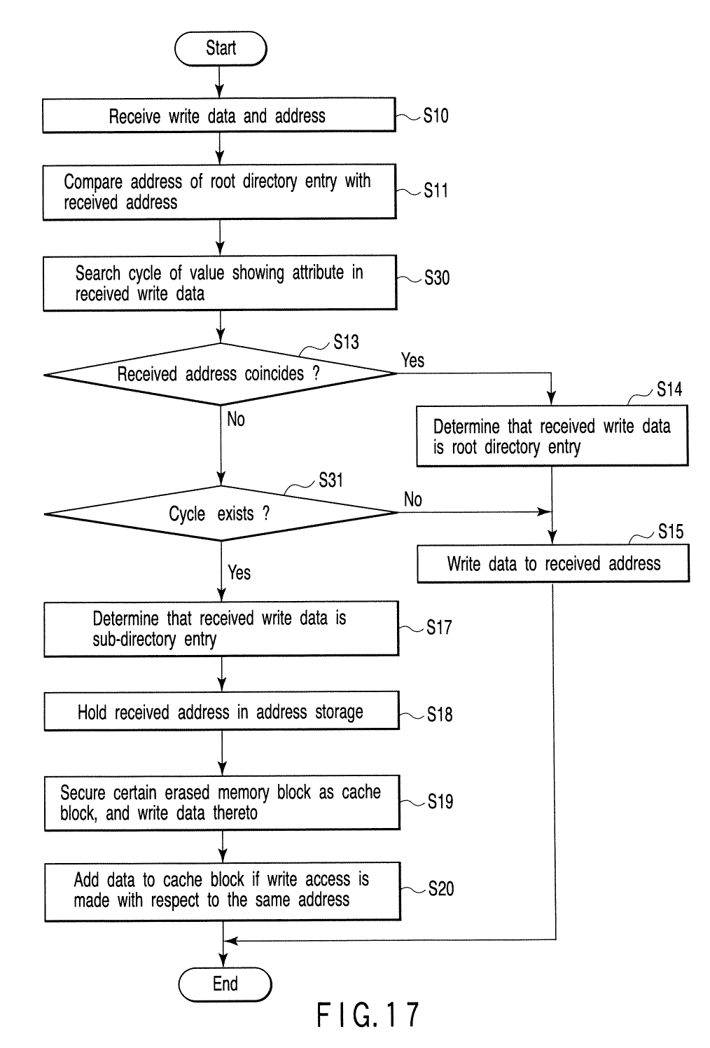

A memory controller according to a second embodiment of the invention will be hereinafter described. The second embodiment relates to a method of detecting a sub-directory entry using the method different from the first embodiment. Thus, the second embodiment is the same as the first embodiment except for the method of detecting the sub-directory entry, and the details of the same are omitted. FIG. 17 is a flowchart to explain a data write method in the memory system according to the second embodiment.

As shown in FIG. 17, the host interface module 20 receives a write command from the host apparatus 2 together with write data and address (step S10). The host interface module 20 outputs the write command and the address to the command/address detector 21 and outputs the write data to the sub-directory entry detector 22.

The command/address detector 21 compares the address A (ROOT) of the root directory entry 44 with the received address (step S11). Then, the command/address detector 21 outputs the comparison result and the write command to the MPU 24. The sub-directory entry detector 22 searches whether or not there exists a cycle of a value showing an attribute in the write data received from the host interface module 20 (step S30). The detector 22 outputs the searched result to the MPU 24, and then, outputs the write data to the data buffer 26.

In step S11, if the address and the received coincide with each other (YES in step S13), the flow proceeds to step S14. Conversely, in step S11, if the address does not coincide (NO in step S13), and in step S30, if the cycle is not detected (NO in step S30), the MPU 24 determines that the write data is a normal data file, and not a root directory and sub-directory entry.

On the other hand, the sub-directory entry detector makes a search; as a result, if the cycle of the value shows the attribute (YES in step S31), the MPU 24 determines that the write data is a sub-directory entry (step S17). The MPU 24 holds the address received from the command/address detector 21 in the address storage 25. Hereinafter, the procedures after step S19 is taken, like the first embodiment.

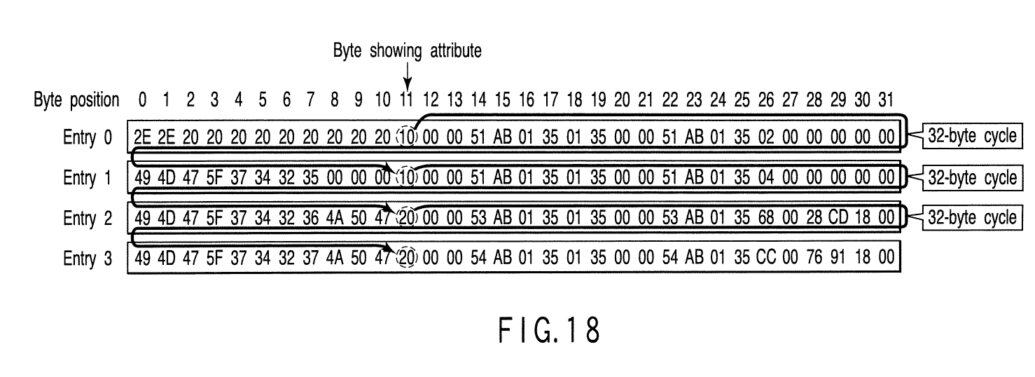

According to the second embodiment, it is possible to detect the sub-directory entry, as in the first embodiment, and high-speed access is realized. This point will be described below with reference to FIG. 18. FIG. 18 is a schematic view showing the sub-directory entry 47. Like FIG. 11, each value is shown using hexadecimal two-digit data.

In the first embodiment, a 0-10 byte position of the entry 0 is taken into consideration. If the value of the 0-10 byte position is “0x2E2E202020202020202020”, it is determined that the data is a sub-directory entry.

On the contrary, according to the second embodiment, an 11-byte position of each of entries 0 to 3 is considered. The value of the 11-byte position shows the attribute as described in the first embodiment. This is the same for any entry. In FIG. 18, “0x10” and “0x20” are used as the value showing the attribute. This attribute shows whether it is a directory or file. Of course, if the attribute shows a read-only or hidden file, a different value is used. The value used as the attribute is always limited. Thus, the value used as the attribute is repeated at predetermined intervals, that is, a 32 byte cycle, and thereby, it is determined that the data is a sub-directory entry.

In FIG. 18, “0x10” and “0x20” are repeated at a 32-byte cycle. Of course, values such as “10” and “20” are used at positions other than the 11-byte position. However, it is a rare case that these values have a cycle at positions other than the 11-byte position. Therefore, according to the method of the second embodiment, it is possible to effectively detect the sub-directory entry.

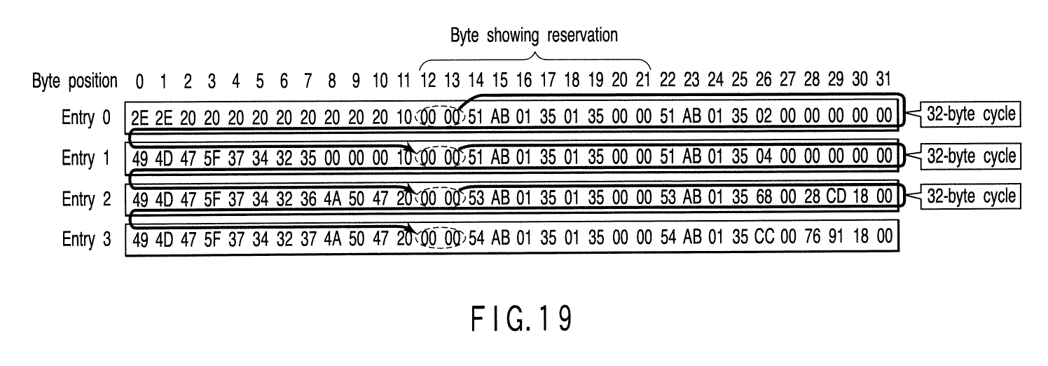

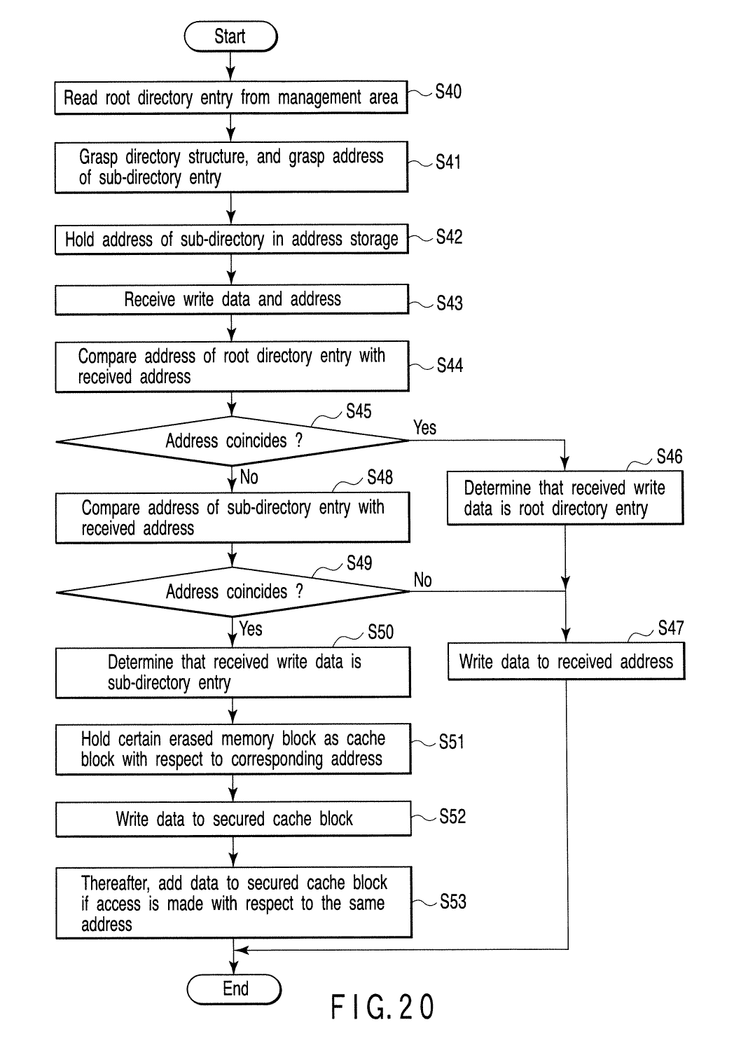

In this second embodiment, it is determined whether or not the data is a sub-directory entry using the value of the 11-byte position of each entry. For example, the same determination may be given using the value showing reservation. This method will be described below with reference to FIG. 19. FIG. 19 is a schematic view showing a sub-directory entry 47, and shows a sub-directory entry having the same data structure as FIG. 11. Like FIG. 11, each value is shown using hexadecimal two-digit data.

As shown in FIG. 19, a 12 to 21-byte position of each entry 0 to 3. The header 2 byte, that is, 12 to 13-byte position is usually “0x0000” in the FAT file system. Namely, in the data, a value “0x0000” is included at a 32-byte cycle. Thus, the value is detected, and thereby, the sub-directory entry may be detected.

The methods described in FIG. 18 and FIG. 19 may be combined. Values of an 11 to 13-byte position of each entry are “value showing the attribute”+“0x0000”. Therefore, it may be determined whether or not the foregoing value is repeated at a 32-byte cycle.

### Third Embodiment

A memory controller according to a third embodiment of the invention will be hereinafter described. The third embodiment relates to a method of detecting a sub-directory entry using the process different from the first and second embodiments. The third embodiment is the same as the first and second embodiments except for the method of detecting a sub-directory entry, and the details of this point are omitted. FIG. 20 is a flowchart to explain a data write method in a memory system according to the third embodiment. The sub-directory entry detector 22 and the pattern storage 23 shown in FIG. 3 are deleted from the configuration of the memory controller 12.

As depicted in FIG. 20, the MPU 24 of the memory controller 12 reads the root directory entry 44 of the management area 41 of the flash memory 11 (step S40). The MPU 24 grasps the directory structure of the flash memory, and grasps an address of a sub-directory entry (step S41). Specifically, from the root directory entry 44, a directory “AAA”, files “FILE1.txt” and “FILE2.txt” exist in the root directory. An address A (AAA) of the sub-directory entry related to “AAA” is calculated from the start cluster number of the directory “AAA”. Access is made with respect to the calculated address to refer to the sub-directory entry 47. In this way, it can be seen that a directory “BBB”, file “FILE1A.jpg” and “FILE2A.jpg” exist in the sub-directory “AAA”. An address A (BBB) of the sub-directory entry 48 related to “BBB” is calculated from the start cluster number of the directory “BBB”. Access is made with respect to the calculated address to refer to the sub-directory entry 48. In this way, it can be seen that files “FILE1B.jpg” and “FILE2B.jpg” exist in the sub-directory “BBB”. Namely, the MPU 24 grasps the directory structure shown in FIG. 7, and grasps addresses of sub-directory entries 47 and 48 related to directory “AAA” and “BBB”. The MPU holds the grasped address in the address storage 25 (step S42).

The host interface module 20 receives a write command from the host apparatus 2 together with write data and address (step S43). The host interface module 20 outputs the write command and the address to the command/address detector 21, and then, outputs the write data to the data buffer 26.

The command/address detector 21 compares the address A (ROOT) of the root directory entry 44 with the received address (step S44). Then, the command/address detector 21 outputs the comparison result and the write command to the MPU 24.

In step S44, if two address coincide with each other (YES in step S45), the MPU 24 determines that the write data is the root directory entry and update instruction of the root directory entry is given (step S46). The MPU 24 gives instructions to write data supplied from the host apparatus 2 in an area corresponding to the received address to the data buffer 26 and the flash controller 27 (step S47).

Conversely, in step S44, if two address do not coincide (NO in step S45), the MPU 24 compares the address of the sub-directory entry held in the address storage 25 with the received address (step S48).

In step S48, if the addresses do not coincide (NO in step 49), the MPU 24 determines that the write data is a normal data file, and not a root directory entry or sub-directory entry. The flow proceeds to step s47. Conversely, in step S48, if the addresses coincide (YES in step 49), the MPU 24 determines that the write data is a sub-directory entry (step S50). Therefore, the MPU 24 secures any erased memory block of the memory array 30 as a cache block with respect to the address (step S51). Then, the MPU 24 writes the data to the cache block secured in step 51 (step S52). Thereafter, if access is made with respect to the same address, the MPU 24 adds the data to the cache block secured in step 51 (step S53).

According to the method of the third embodiment, it is possible to detect the sub-directory entry, and obtain the effect described in the first embodiment.

As described above, the memory controller according to the first to third embodiments of the invention can detect both a root directory entry and sub-directory entry. Thus, a cache block is effectively provided with respect to the sub-directory entry, and high-speed access to the memory card 1 is possible.

Specifically, according to the configuration of the first embodiment, the memory controller 12 includes control circuits (command/address detector 21, sub-directory entry detector 22, pattern storage 23 and MPU 24). The control circuit searches for information (“0x2E2E202020202020202020”) showing the existence of the parent directory from the data received from the host interface (host interface module 20). If the information is detected, the holding circuit (address storage 25) holds address of the data, and secures a new non-use memory block. Thereafter, the control circuit further adds and writes the data to the same memory block (secured memory block) as described in FIG. 13 if a new write access is made with respect to the address held in the holding circuit. The foregoing data add and write is not an overwrite, and means a write to non-use page, and is carried out in page units.

According to the second embodiment, the control circuit (command/address detector 21, sub-directory entry detector 22, pattern storage 23 and MPU 24) detects whether or not a predetermined value is repeated at fixed intervals. If the predetermined value is included, the holding circuit (address storage 25) holds address of the data, and secures a new non-use memory block. The predetermined value means a value such that if the data is a sub-directory entry, information shown by the entry included in the sub-directory entry shows information related to a directory or information related to a file. Thereafter, the control circuit further adds and writes the data to the same memory block (secured memory block) as described in FIG. 13 if a new write access is made with respect to the address held in the holding circuit and the same address.

According to the third embodiment, the control circuit (command/address detector 21 and MPU 24) reads the root directory entry from a semiconductor memory. Then, the control circuit calculates the address of the sub-directory entry included in the semiconductor memory. The control circuit gives instructions to hold the calculated address of the sub-directory entry to the holding circuit (address storage 25). The holding circuit holds the address of the sub-directory entry, and thereafter, the control circuit newly secures a new non-use memory block if a first write access is made with respect to the address. Then, the control circuit writes data to the secured memory block. Thereafter, the control circuit further adds and writes the data to the same memory block (secured memory block) as described in FIG. 13 if a new write access is made with respect to address held in the holding circuit.

According to the first embodiment, the case of searching for “0x2E2E202020202020202020” as parent directory information is given as an example. However, all of the 11-byte values are not always searched, and the header “0x2E2E” only or “0x2E2E2020” only may be searched. In this case, search accuracy is reduced; however, the effect is obtained to some degree. The value of “0x2E2E202020202020202020” is given as the parent directory information. The value is merely one example in the FAT file system, and there is a possibility that a different value may be used in another file system; in this case, the same process is employed. In other words, the value to be detected is not limited so long as the existence of the parent directory is detected by referring to the content of the write data.

According to the first embodiment, the case where the parent directory information is held in the first entry 0 as shown in FIG. 10 is given as an example. In this case, there is no need of holding the information in the first entry. Usually, in the FAT file system, current directory information is held in the first entry, and parent directory information is held in the next entry.

In the first to third embodiments, if the write data is a root directory entry, any of the erased memory blocks is preferably used as a cache memory block.

In the first and second embodiments, the sub-directory entry detector 22 detects the sub-directory entry. In this case, the sub-directory entry may be detected using the software in the MPU 24. The root directory entry may also be detected, using the foregoing software.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory controller controlling a semiconductor memory, the semiconductor memory including memory blocks each having nonvolatile memory cells, data in each of the memory blocks being erased simultaneously, the memory controller comprising:
a host interface which is configured to be connectable to a host apparatus and receivable of write data and an address from the host apparatus;
a holding circuit which is configured to be capable of holding the address; and
a control circuit which searches information indicating an existence of a parent directory from the write data, and holds the address in the holding circuit when the information is detected, the control circuit successively writing the write data to the same memory block when a new write access is made with respect to the same address as the address held in the holding circuit.

2. The controller according to claim 1, wherein the control circuit includes
a parent directory information storage which holds a value of the information indicating the existence of the parent directory;
a detector which detects an existence of the information in the write data by searching whether or not the value held in the parent directory information storage is included in the write data; and
a controller which instructs the holding circuit to hold the address when the detector detects the information.

3. The controller according to claim 1, wherein the control circuit newly secures any of the memory block, and write the write data to the secured memory block when the information is detected.

4. The controller according to claim 1, wherein the write data in which the information is detected is a sub-directory entry showing sub-directory information in a FAT file system.

5. The controller according to claim 1, wherein a code of the information includes “0x2E2E20”.

6. The controller according to claim 1, wherein each of the memory blocks includes
memory cell blocks each of which includes a first select transistor, a second select transistor, and memory cell transistors having a current path series-connected between a source of the first select transistor and a drain of the second select transistor; and
word lines each of which connects commonly gates of the memory cell transistors in the same row between different memory cell blocks,
the write data is written simultaneously to the memory block in units of page which is a set of the memory cell transistors connected to the same one of the word lines,
the control circuit newly secures any of the memory blocks when the information is detected, and write the write data to the secured memory block in units of the page,
the control circuit write the write data to a non-use page of the secured memory block when new write access is made with respect to the same address as the address held in the holding circuit.

7. A memory controller controlling a semiconductor memory, the semiconductor memory including memory blocks each having nonvolatile memory cells, data in each of the memory blocks being erased simultaneously, the memory controller comprising:
a host interface which is configured to be connectable to a host apparatus and receivable of write data and an address from the host apparatus;
a holding circuit which is configured to be capable of holding the address; and
a control circuit which detects whether or not a predetermined value is repeatedly included at predetermined intervals in the write data, and if included, holds the address in the holding circuit, the predetermined value being a value indicating whether information shown by an entry included in a sub-directory entry relates to a directory or a file when the write data is a sub-directory entry, the control circuit successively writing the write data to the same memory block when new write access is made with respect to the address held in the holding circuit and the same address.

8. The controller according to claim 7, wherein the control circuit includes
a detector which detects an existence of a cycle of the predetermined value in the write data; and
a controller which instructs the holding circuit to hold the address when the detector detects the cycle.

9. The controller according to claim 7, wherein the control circuit newly secures the memory block, and writes the write data to the secured memory block when a repeat of the predetermined value is detected.

10. The controller according to claim 7, wherein the write data in which a repeat of the predetermined value is detected is a sub-directory entry showing sub-directory information in a FAT file system.

11. The controller according to claim 7, wherein a code of the predetermined value includes “0x10” or “0x20”.

12. The controller according to claim 7, wherein each of the memory blocks includes
memory cell blocks each of which includes a first select transistor, a second select transistor, and memory cell transistors having a current path series-connected between a source of the first select transistor and a drain of the second select transistor; and
word lines each of which connects commonly gates of the memory cell transistors in the same row between different memory cell blocks,
the write data is written simultaneously to the memory block in units of page which is a set of the memory cell transistors connected to the same one of the word lines,
the control circuit newly secures any of the memory blocks when a repeat of the predetermined value is detected, and write the write data to the secured memory block in units of the page,
the control circuit write the write data to a non-use page of the secured memory block when new write access is made with respect to the same address as the address held in the holding circuit.

13. A memory controller controlling a semiconductor memory, the semiconductor memory including memory blocks each having nonvolatile memory cells, data in each of the memory blocks being erased simultaneously, the memory controller comprising:
a host interface which is configured to be connectable to a host apparatus and receivable of write data and an address from the host apparatus;
a control circuit which reads a root directory entry from the semiconductor memory, and calculates an address of a sub-directory entry included in the semiconductor memory; and
a holding circuit which holds the address of the sub-directory entry calculated by the control circuit, the control circuit successively writing the write data to the same memory block when a new write access is made with respect to the same address as the address held in the holding circuit.

14. The controller according to claim 13, wherein the control circuit instructs the holding circuit to hold the address of the sub-directory entry, and thereafter, newly secures any of the memory block when first write access is made with respect to the address of the sub-directory entry, and writes the write data to the secured memory block.

15. The controller according to claim 13, wherein each of the memory blocks includes
memory cell blocks each of which includes a first select transistor, a second select transistor, and memory cell transistors having a current path series-connected between a source of the first select transistor and a drain of the second select transistor; and
word lines each of which connects commonly gates of the memory cell transistors in the same row between different memory cell blocks,
the write data is written simultaneously to the memory block in units of page which is a set of the memory cell transistors connected to the same one of the word lines,
the control circuit newly secures any of the memory blocks when first write access is made with respect to the address of the sub-directory entry after holding the address of the sub-directory entry in the holding circuit, and write the write data to the secured memory block in units of the page,
the control circuit write the write data to a non-use page of the secured memory block when new write access is made with respect to the same address as the address held in the holding circuit.

16. A memory system comprising:
a memory controller recited in claim 1; and
the semiconductor memory.

17. A memory system comprising:
a memory controller recited in claim 7; and
the semiconductor memory.
